(19) United States
(12) Patent Application Publication
(10) Pub. No.: US 2025/0222541 A1
(43) Pub. Date: Jul. 10, 2025

(54) METHOD AND APPARATUSES FOR PRODUCING CUSTOMIZED ETCHED ARTICLES

(71) Applicant: Communications Test Design, Inc., West Chester, PA (US)

(72) Inventor: Timothy HOPFER, Downingtown, PA (US)

(73) Assignee: Communications Test Design, Inc., West Chester, PA (US)

(21) Appl. No.: 18/850,346

(22) PCT Filed: Mar. 23, 2023
(86) PCT No.: PCT/US2023/016114

§ 371 Date: Sep. 24, 2024

Related U.S. Application Data
(60) Provisional application No. 63/323,240, filed on Mar. 24, 2022.

(51) Int. Cl. B23K 26/08; B23K 26/362

(52) U.S. Cl. CPC B23K 26/083; B23K 26/362

(57) ABSTRACT

Methods and apparatuses for automatically producing customized etched articles on demand are disclosed. In an embodiment, a first set of etching instructions is received. A second set of etching instructions are determined from the first set of etching instructions and from a predetermined set of etching parameters. An etching device etches a designated article based on the second set of etching instructions.

### PRIORITY CLAIM

This application is a national stage application claiming the benefit of Patent Cooperation Treaty Application No. PCT/US2023/016114, filed on Mar. 23, 2023, which claims the benefit of U.S. Provisional Application No. 63/323,240 filed on Mar. 24, 2022. The above identified patent application is herein incorporated by reference in its entirety to provide continuity of disclosure.

### FIELD

The present disclosure relates to methods and apparatuses for producing customized etched articles.

### BACKGROUND

This section provides background information related to the present disclosure which is not necessarily prior art.

Some articles may be enhanced or be more desirable if the article is customized or otherwise includes a personalized aspect. One process that may be used to produce a customized or personalized aspect on an article is etching. Etching can be used, for example, to permanently mark various articles with words, messages, designs, names or other expressions. Existing methods and apparatuses of producing articles with etched expressions suffer from various drawbacks. Such drawbacks can include errors in the customized expressions and/or other defects. Existing methods and apparatuses often increase costs for sellers due to waste, returns and/or reduced customer satisfaction. There exists a need, therefore, for improved methods and apparatuses for producing customized etched articles.

### SUMMARY

This section provides a general summary of the disclosure, and is not a comprehensive disclosure of its full scope or all of its features.

In some embodiments in accordance with the present disclosure, apparatuses for producing customized etched articles are provided. Example apparatuses may include an etching engine. The etching engine may be coupled to one or more computing devices, databases and an etcher. The etching engine may be configured to obtain article orders via a communications network and extract customization detail from the article orders. The etching engine may transform the customization detail from the articles orders and send the customization detail to an etcher. The etcher may then etch a desired article in accordance with the customization detail. The etching engine may then verify that the etched article corresponds to the article order.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a diagram of an etching system in accordance with some embodiments of the present disclosure.

FIG. 2 is a diagram of an example computing device that may be used in the etching systems of the present disclosure.

FIG. 3 is an image showing an example etching system that may include an etching engine in accordance with the present disclosure.

FIG. 4 is an image showing the etcher of the etching system of FIG. 3 in which the chamber of the etcher is in open position and an article is positioned on an article mount therein.

FIG. 5 is an image showing an example fixture holding an article in the chamber of the etcher.

FIG. 6 is an image showing an example user interface of the etching engine in accordance with one or more embodiments of the present disclosure.

FIG. 7 is an example method of etching an article in accordance with one or more embodiments of the present disclosure.

Corresponding reference numerals indicate corresponding parts throughout the several views of the drawings.

### DETAILED DESCRIPTION OF THE INVENTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In various embodiments as further described below, the present disclosure is directed to etching systems that can be used to permanently etch custom izations, markings and expressions on various articles. While the teachings and principles of the present disclosure can be applied broadly to various articles, the disclosure below describes an embodiment in which etchings are placed onto a doorbell cover plate. It should be appreciated that the etchings can also be placed on other articles as known to one of ordinary skill in the art.

In some examples, the etching system can include a computing device with an etching engine coupled to an etcher. The etching engine can be configured to obtain information regarding an order for an article and the custom izations that a customer may desire to place on the article. Custom izations may include, for example, words, designs, phrases, pictures, crests, addresses, instructions, names, and the like. The order information can be transformed or undergo an extraction process in which the etching engine can extract the information required to provide instructions for an etcher to fix the custom izations on the article. This process can be automatically completed by the etching engine. With suitable etching instructions from the etching engine, the etcher can perform the etching process to fix the customization on the article in accordance with the order information.

In some examples, the etching engine can verify that the customization that is fixed on the article corresponds to the order information. This process can be completely automatic with minimized or reduced operator interaction so as to minimize errors and/or defects during the etching process. The etching engine may, for example, include one or more user interfaces to obtain and transfer accurate and complete instructions to the etcher. The etching systems of the present disclosure are improvements over existing systems and methods by reducing errors, improving cycle time and decreasing a likelihood of defects. These improvements, in turn, can provide reduced costs, improved revenue and improved customer satisfaction for sellers of customized articles.

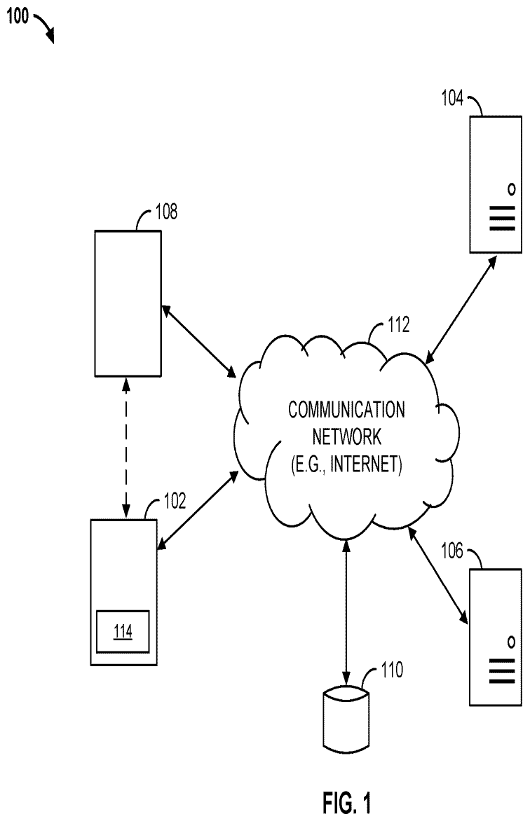

Referring now to FIG. 1, an example etching system 100 is shown. In this example, the etching system 100 includes an etching computing device 102, an ordering server 104, a web server 106, an etcher 108, a database 110 and a communication network 112. The etching system 100 can operate to perform the functions, operations and methods as further described in the present disclosure. As can be appreciated, other etching systems can also be used to provide the functionality as described herein such as, for example, variations of etching system 100 that include additional elements or variations with less elements than those shown in FIG. 1.

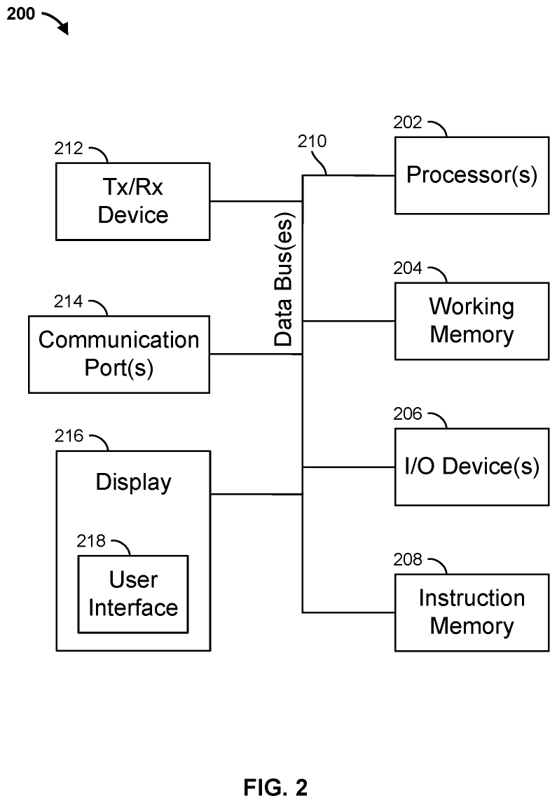

The etching computing device 102 can be any suitable computing device such as the computing device 200 shown in FIG. 2. In one example, the etching computing device 102 is a workstation, laptop, desktop or other personal computing device. In other examples, the computing device can be other devices such as a smartphone, tablet, or the like. The etching computing device 102 may include an etching engine 114. The etching engine 114 can be, for example, an application, software, set of executable instructions or the like. The etching engine 114 can include, for example, a set of executable instructions that provide the functions or perform one or more methods described in the present disclosure.

The etching system 100 may also include the ordering server 104 and the web server 106. The ordering server 104 and/or the web server can be any suitable server or other computing device. The ordering server 104 and the web server 106 may be operated by a seller or retailer of the articles that are etching using the methods and apparatuses of the present disclosure. The ordering server 104 and the web server 106 may, for example, operate to display an ecommerce website. A consumer may also be connected to the communication network 112 to access the ecommerce website and place an order for a customized article by interacting with the ordering server 104 and/or the web server 106.

The ordering server 104 may, for example, obtain and store article orders that describe an article that has been ordered by a customer. The article orders may include various pieces of information such as an identity of the customer, an address, billing information and the like. The article order may also include article information such as type, model, size, shape, color, stock ID, for the article that has been ordered by the customer. The article order may also include customization information. The customization information may include information that describes the customized wording, design, or other markings or expressions that the customer desires to place on the article. The ordering server 104 may store the article orders locally or may store the article orders in a separate storage medium or server or in the database 110.

In various methods of use, the etching system 100 may operate share information and data via the communication network 112. The communication network 112 can be any suitable communication system that allows the various elements of the etching system 100 to share information and/or data. The communication network 112 may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes may include any mode of communication between points (e.g., nodes) that utilize, at least in part, wireless technology including various protocols and combinations of protocols associated with wireless transmission, data, and devices. The points include, for example, wireless devices such as mobile telephones, computers and computer-related devices and components, such as printers, network-connected machinery such as a circuit generating system, and/or any other suitable device or third-party device. Wireless communications may include, for example, local area network (WLAN) protocols, including the Institute of Electrical and Electronics Engineers (IEEE) 802. xx series of protocols, such as IEEE 802.11 a/b/g/n, IEEE 802.16, IEEE 802.20, and so forth. Other examples of wireless protocols may include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

Wired communication modes include any mode of communication between points that utilize wired technology including various protocols and combinations of protocols associated with wired transmission, data, and devices. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fiber Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

FIG. 2 illustrates an example computing device 200. The etching computing device 102, the ordering server 104, and/or the web server 106 may include the features shown in FIG. 2. For the sake of brevity, FIG. 2 is described relative to the etching computing device 102. It should be appreciated, however, that the elements described can be included, as applicable, in the ordering server 104, the web server 106, and/or other computing devices that are part of the etching system 100 or that may work in connection with the etching system 100.

As shown, the etching computing device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of etching computing device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (LIART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as article orders, customization information, and the like.

Display 216 can display a user interface 218. User interfaces 218 can enable user interaction with the etching computing device 102. For example, user interface 218 can be a user interface that allows an operator to interact, communicate, control and/or modify different operations, settings, or features that may be presented or otherwise displayed to a user by a network-enabled tool such as a workstation. The user interface 218 can include a slider bar, dialogue box, or other input field that allows the user to control, communicate or modify a setting, limitation or input that is used in an etching process. In addition, the user interface 218 can include one or more input fields or controls that allow a user to modify or control optional features or customizable aspects of the etching computing device. In some examples, a user can interact with user interface 218 by engaging input-output devices 206. In some examples, display 216 can be a touchscreen, where user interface 218 is displayed on the touchscreen. In other examples, display 216 can be a computer display that can be interacted with using a mouse or keyboard.

Transceiver 212 allows for communication with a network, such as the communication network 112 of FIG. 1. For example, if communication network 112 of FIG. 1 is a cellular network, transceiver 212 is configured to allow communications with the cellular network. In some examples, transceiver 212 is selected based on the type of communication network 112. Processor(s) 202 is operable to receive data from, or send data to, a network, such as communication network 112 of FIG. 1, via transceiver 212.

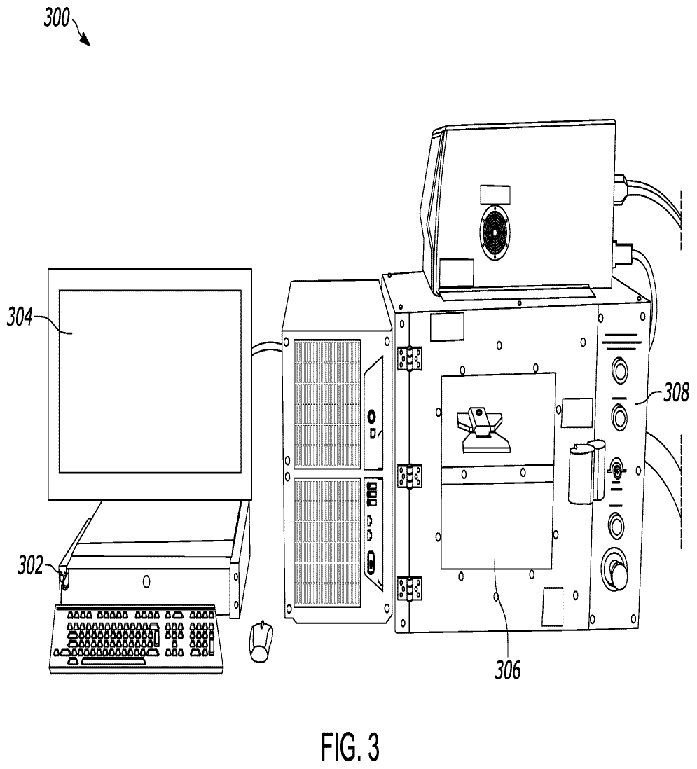

Referring now to FIG. 3, an example etching system 300 is shown. In this example, the etching system 300 includes an etching computing device 302 and etcher 308. The etching computing device and the etcher 308 may be coupled together using any suitable wired or wireless communication network as previously described. The etching computing device 302 in this example is configured as a workstation and includes a display 304. A user of the etching system can interact with the etching computing device 302 using input mechanisms such as the keyboard and mouse as shown and can view the etching user interface via the display 304.

The etcher 308, in this example, is a laser etching device that includes an etching laser in the chamber 306 of the etcher 308. The chamber 306 can be opened and an article can be placed inside the chamber 306. After the chamber 306 is closed, the etching process can be initiated in which the laser may follow a predetermined etching path to etch customized words, pictures, expressions or other ornamental designs to be permanently etched onto one or more surfaces of the article.

The etching system 300 can be used, for example, to etch customized designs onto one or more surfaces of a doorbell faceplate. In other examples, various etching systems 300 can be provided to etch customized designs onto one or more surfaces of other articles. In still other examples, the teachings and principles of the present disclosure can be applied and used with other etchers or other design apparatuses such as printers, milling machines, CNC machines, 3D printers, and the like.

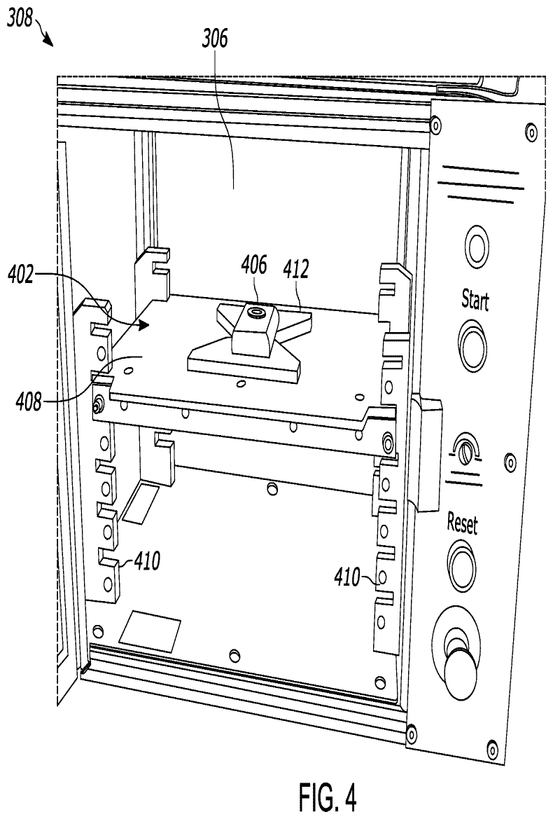

FIG. 4 shows the etcher 308 with the chamber 306 in an open position. As shown, the chamber 306 may be sized and configured to include a support fixture 402. The support fixture 402 can be used to support and retain an article 406 therein. The support fixture 402 can retain the article 406 in a predetermined position in the chamber 306 so that when the etching tool (e.g., laser tool) moves, the customized design is placed in the desired position on the article 406. In this example, the support fixture 402 includes a platform 408, one or more stanchions 410 and a locator 412. The platform 408 may be a substantially horizontal member that supports the article 406 at a vertical height in the chamber 306. The stanchions 410, in this example, are vertical members that support the platform 408 at a desired vertical position. As can be seen, the stanchions 410 may include one or more notches, holes, or other features that can be used to selectively position the platform 408 at a desired vertical position in the chamber 306. In this example, the platform 408 is supported in one of several notches on each of the stanchions 410.

In other examples (not shown), one or more portions of support fixture 402 may be configured to move automatically or otherwise to allow a user to position the article at a desired location in the chamber 306. For example, the stanchions 410 may be configured as pneumatic cylinders or as worm screws that are coupled to the platform 408. Such stanchions can be used to move the platform 408 vertically in the chamber. Such a configuration may be desirable in instances in which articles of varying sizes are etched using the systems of the present disclosure. The support platform 408 can be automatically, mechanically, or otherwise varied according to the size of the article or to accommodate different types, models or other variations of the article 406.

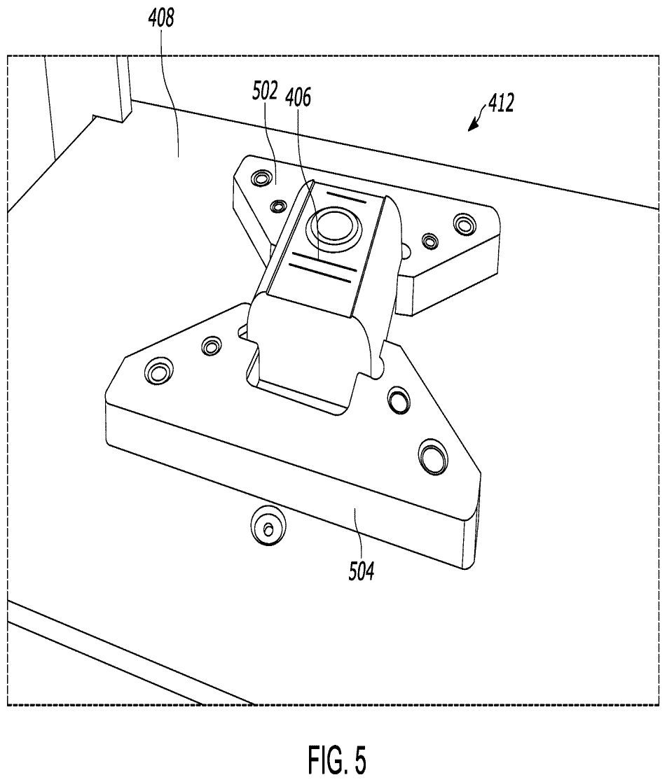

As shown in FIG. 5, the article 406 can be supported on the platform 408 and retained from lateral movement by the locator 412, In this example, the locator 412 include a first portion 502 and a second portion 504. The first portion 502 and the second portion 504 can be fixed to the platform 408 using fasteners or other suitable attachments. The first portion 502 can support one side of the article 406 and the second portion 504 can support the opposite side of the article 406. As can be appreciated, the first portion 502 and the second portion 504 are sized to at least partially surround the article 406 to limit movement of the article 406 on the platform 408. In other examples, the locator 412 can have other shapes or other configurations to limit movement of the article 406 and to position the article 406 in a desired location on the platform 408. In other examples, the locator 412 may include pins, holes, bars or other features that can contact complimentary holes or pins or can contact one or more sides of the article 406.

While not shown, the etching tool (e.g., laser tool) may move relative to the article 406 to etch the customized design onto the article 406. In other examples, the etching tool may be stationary and the support fixture 402 may be configured to move the article 406 relative to the etching tool to etch the customized design onto the article 406.

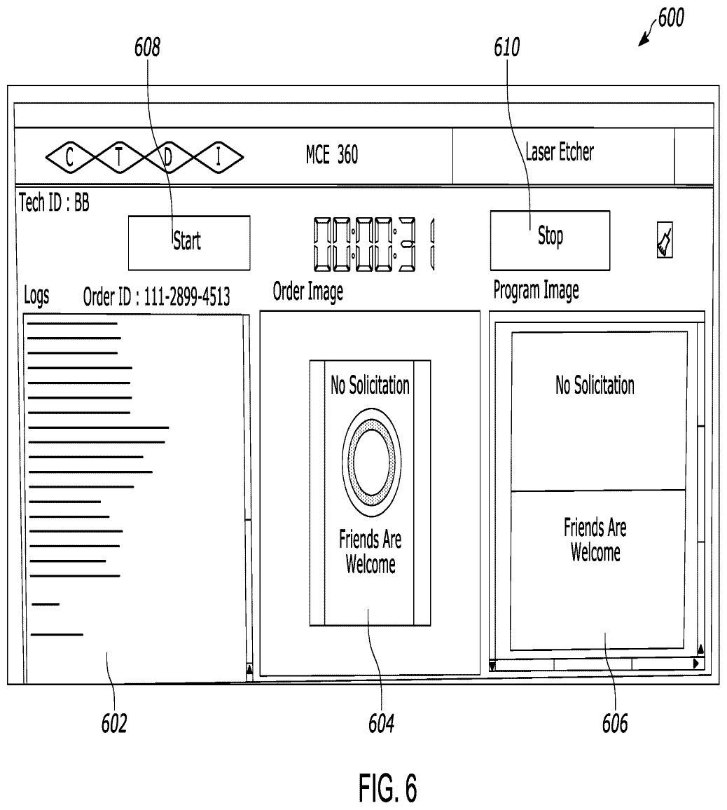

An example etching user interface 600 is shown in FIG. 6. In the example, the etching user interface 600 includes a log display 602, an order image display 604, a program image display 606, an etching initiation selector 608 and an etching stop selector 610. The etching user interface 600 can, for example, be displayed by the etching computing device 302. The etching user interface 600 can allow a user to interact with the etching engine and/or the etching computing device 302. The etching user interface 600 may permit, for example, a user to initiate one or more etching methods of the present disclosure and/or to produce customized etched articles.

In the example shown, the etching user interface 600 can allow the user to perform the steps of method 700 that will be further described below. The etching user interface 600 can allow a user to initiate the method by selecting the etching initiation selector 608. The user can initiate one or more steps by pressing (or selecting) the etching initiation selector 608 using a mouse, keyboard, touch screen or the like.

The log display 602 of the user interface 600 can display the operations of the etching engine and/or the steps being performed by the etching computing device 302. The log display 602 can display article orders that are retrieved from an order repository and display the customization detail that may be extracted from the article orders. The log display 602 can also display a status of the etcher 308 and display when steps of the etching process have completed and/or if any errors are encountered during the process. The log display 602 may also display an identification number or other information related to the processing of etched articles.

The order image display 604 may display an image of the article to be etched and/or a virtual image of the article showing its appearance after the article has been etched. The virtual image can, for example, be used to verify an article order or to verify that the contents of the customization detail will fit onto the article. Such verification can be performed by the user or alternatively can be automatically performed by the etching computing device 302.

The program image display 606 may show the customization detail from the article order in a format that represents the positioning system of the etcher 308. For example, the program image display 606 may show the customization detail aligned in a coordinate system that is used by the etcher to move and position the etching tool to create the customized design on the article.

In other examples, the etching user interface 600 may include other displays, controls and indicators that can prompt the user to perform certain actions and/or to provide other information or status of the process. In still other examples, the etching user interface 600 may include other fields or inputs that may allow the user to provide, change or indicate parameters of the etching process. Such additional parameters may include, for example, a size depth or color for the etch or other design.

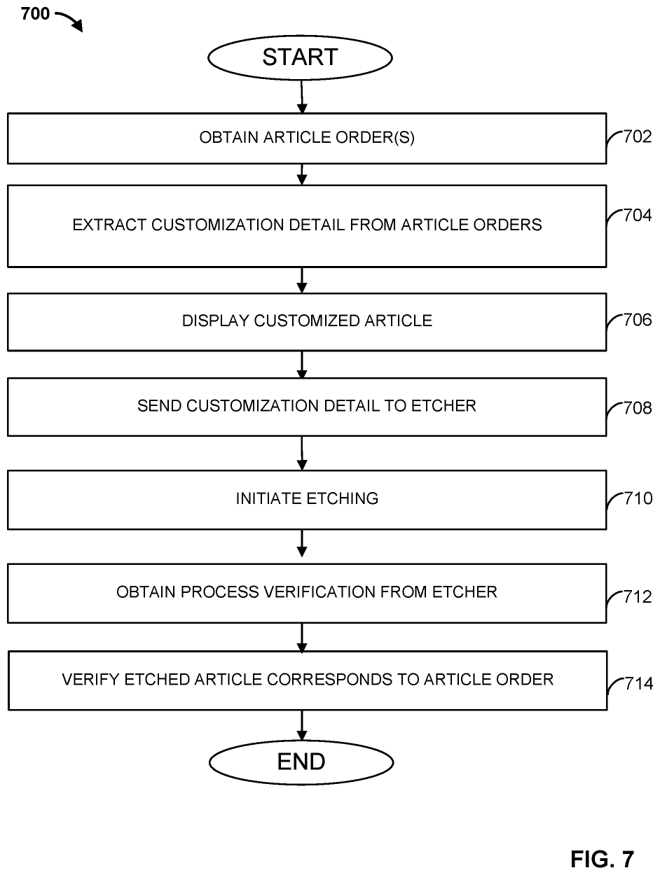

Referring now to FIG. 7, an example method 700 of etching an article is shown. The method 700 may be performed by one or more etching systems as described above. For the sake of brevity, the method 700 is described with reference to the etching system 300. It should be appreciated, however, that other etching systems can be used as well as applying one or more of the steps of method 700 to other systems that may provide customization of articles such as to printers, CNC machines, 3D printers and the like.

The method 700 begins at step 702. At step 702, the etching computing device 302 may obtain article orders from an order repository. This step may be performed automatically by the etching computing device 302 or when the action is initiated by a user. For example, the user may select the etching initiation selector 608 (FIG. 6) of the etching user interface 600 to retrieve the article orders. The article orders may be stored in a database or in a server such as ordering server 104 or database 110 of system 100 (FIG. 1). The etching engine of the etching computing device 302 may include suitable application protocol interfaces (APIs) to communicate with the ordering server or the database.

In one example, the ordering server 104 is operated by a seller that provides an ecommerce marketplace that markets and sells customized articles such as customized doorbell faceplates. The seller can allow the customer to input a desired customization that he/she desires to be etched onto the surface of the article. The customized design can be stored by the seller in the article order that can also include customer information and article information. The customization detail, the customer information and the article information can be stored by the seller as an article order.

The etching engine of the etching computing device 302 may collect or obtain the article orders from the seller. The article order, however, that has been obtained by the etching computing device 302 cannot be immediately used to create the customized article. The article order is stored and subsequently obtained by the etching computing device 302 in a seller format. That is, the customization detail may not be stored in a format that can be immediately translated to etching instructions without first undergoing some type of extraction that can re-format, transform or otherwise process the article order into etching instructions that can be used by the etcher to create the customized design.

At step 704 of method 700, the etching computing device 302 may extract customization detail from the article orders. The etching engine of the etching computing device 302 may perform the extraction. The extraction may include any suitable processing of the article orders such a identifying the customization detail, truncating the data, removing data, or allocating variable or fields in the article data to customization fields in the etching program.

At step 706, the etching computing device 302 may display the customized article. The customized article may be displayed in the order image display 604 of the etching user interface 600, for example. The display of the customized order may allow the user to verify the appearance of the customized article and to make adjustments or other revisions as may be necessary to ensure that the customized design fits on the article or will otherwise result in a satisfactory product for the customer.

At step 708, the etching computing device 302 may send the customization detail to the etcher 308. The customization detail may be sent using any suitable data transfer process and/or wired or wireless communication network. The customization detail may be sent in a suitable format after the extraction and/or transformation process previously described. The customization detail may be sent as part of an etching program, for example. The customization detail may include information regarding the design of the customization detail and/or include the wording or expression that the customer desires to include on the article. The customization detail may also include one or more etching parameters that may include a thickness of the etch and/or a depth of the etch. The etching parameters may be pre-defined for the particular type, model, size or color of the article. In some instances, the etching parameters may be pre-defined using extensive testing that may be performed on various articles. For example, a depth of the etch may need to be tested on articles to define a desired appearance of the etch. This etch depth may be provided be pre-defined for each type, model or color of article. In other examples, other etching parameters may be similarly pre-defined for various articles.

While not shown in FIG. 7, the etching computing device 302 may prompt the user to perform one or more actions in connection with the etching method. For example, the etching user interface 600 may display prompts or commands to the user. The etching computing device 302 may prompt the user to position the article in the etcher 308. The user may position the article in the support fixture in the chamber of the etcher 308. The etcher may include proximity sensors or other optical sensors that can verify that the article has been positioned in the etcher 308. The user may also have to verify placement of the article by selecting a button or other input on the etching user interface 600.

At step 710, the etching computing device may initiate etching of the article. The etching computing device 302 may send a signal to the etcher to initiate the etching. The etcher 308 may then etch the article in accordance with the instructions sent by the etching computing device that corresponds to the customization detail extracted at step 704.

The etcher will continue to etch the article until the etching is complete. At step 712, the etching computing device 302 may obtain process verification from the etcher 308. The etching computing device 302 can receive a signal or other communication from the etcher. The etching computing device 712 may display a status and/or a completion message on the etching user interface 600. In some examples, if the etching process is interrupted or encounters problems with completion of the etch, the etching computing device 302 may receive an error indication that includes information regarding the interruption and may prompt the user to re-start the process or to take other corrective actions.

At step 714, the etching computing device 714 may verify that the etched article corresponds to the article order. Such a verification may include comparing the customization detail to the appearance of the etched article. The comparison can be performed using optical sensors or by verifying that no errors were encountered during the etching process. A verification message or indicator may then be displayed by the etching computing device 302 on the etching user interface, for example.

In various alternate embodiments and methods, one or more aspects of the method 700 may be combined and/or automated. In some examples, user interaction can be minimized or reduced. The articles can be moved into the chamber 306 of the etcher 308 using robotic manipulators. In other examples, the articles may be loaded or moved into the chamber using conveyors or other material handling devices.

While the foregoing has been described to include the customization of a doorbell faceplate, the teachings and principles of the present disclosure can be used to customize, etch, print, engrave or otherwise mark other articles such as cell phones, tablets, laptops, other faceplates, covers, and the like.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. A system for etching an article, comprising: a communication network operably interconnecting an etching computing device, a memory device, and an etching device; said etching computing device comprising an etching engine for determining a second set of etching instructions from a first set of etching instructions and from a predetermined set of etching parameters; said etching device comprising a user interface and an etching chamber; and said etching chamber comprising a support device, a locator, and an etching tool, wherein said etching tool receives the second set of etching instructions from the etching computing device and etches the article using the second set of etching instructions.

2. The system of claim 1, wherein the first set of instructions is received from a remote computing device.

3. The system of claim 1, wherein the first set of instructions includes instructions identifying a designated article to be etched.

4. The system of claim 3, wherein the etching parameters are based at least in part on a spatial dimension of the designated article.

5. The system of claim 1, wherein the second set of instructions includes instructions to automatically adjust at least one of the support device and the locator.

6. The system of claim 5, wherein the support device is configured to be adjusted in a first direction.

7. The system of claim 5, wherein the locator is configured to be adjusted in a second direction, wherein the second direction is different than the first direction.

8. The system of claim 7, wherein the locator comprises a first portion and a second portion, and wherein the first portion is configured to be adjustable independent of the second portion.

9. The system of claim 1, wherein said etching device further comprises a display device configured to display a first image and second image.

10. The system of claim 9, wherein the first image is a virtual image of the article and the second image is an image based on the second set of etching instructions.

11. A method for etching an article, the method comprising the steps of: receiving, at an etching computing device, a first set of etching instructions and a predetermined set of etching parameters; determining, at the etching computing device, a second set of etching instructions from the first set of etching instructions and from the predetermined set of etching parameters; transmitting, from the etching computing device to the etching device, the second set of etching instructions; and etching the article based on the second set of etching instructions.

12. The method of claim 11, wherein the first set of instructions is received from a remote computing device.

13. The method of claim 11, wherein the first set of instructions includes instructions identifying a designated article to be etched.

14. The method of claim 13, wherein the etching parameters are based at least in part on a spatial dimension of the designated article.

15. The method of claim 11, wherein the second set of instructions includes instructions to automatically adjust at least one of the support device and the locator.

16. The method of claim 15, wherein the second set of instructions includes instructions to adjust the support device in a first direction and instructions to adjust the locator in a second direction, wherein the second direction is different than the first direction.

17. The method of claim 11, further comprising the step of displaying on a display device a first image and second image.

18. The method of claim 17, wherein the first image is a virtual image of the article and the second image is an image based on the second set of etching instructions.

19. A system for etching articles comprising: an etcher configured to support an article; and one or more computing devices including at least one processor, the one or more computing devices configured to: obtain article orders from an order repository, the article orders comprising article information and customization detail; extract the customization detail from the article orders; send the customization detail to the etcher; and initiate etching of the article by the etcher based on the customization detail.

20. A system for etching articles comprising: an etcher comprising an etching tool and a fixture for retaining an article; and an etching computing device, the etching computing device configured to display an etching user interface, the etching user interface comprising a customized article display, an article order retrieval selector and an etching initiation selector, wherein the etching computing device is configured to: obtain article orders from an order repository when a user selects the article order retrieval selector on the etching user interface; display a virtual image of a customized article on the customized article display of the etching user interface based on customization detail of at least one article order; and initiate etching of the article based on the customization detail of the at least one article order when the user selects the etching initiation selector of the etching user interface.
